(19) United States
(12) Patent Application Publication
(10) Pub. No.: US 2021/0017090 A1
(43) Pub. Date: Jan. 21, 2021

(54) THERMAL SPRAY DEPOSITED COATING

(71) Applicant: Rolls-Royce Corporation, Indianapolis, IN (US)

(72) Inventors: Jun Shi, Carmel, IN (US); Li Li, Carmel, IN (US)

(21) Appl. No.: 16/929,978

(22) Filed: Jul. 15, 2020

Related U.S. Application Data
(60) Provisional application No. 62/876,450, filed on Jul. 19, 2019.

(51) Int. Cl. C04B 41/45; C04B 41/00; C04B 41/52; C04B 41/50; C04B 35/565

(52) U.S. Cl. CPC C04B 41/4527; C04B 41/0072; C04B 41/52; C04B 41/5024; C04B 2235/96; C04B 2235/6567; C04B 2235/76; C04B 2235/3826; C04B 35/565

(57) ABSTRACT

In one example, a method for forming an environmental barrier coating (EBC) on a substrate. The method may include heating the substrate before and/or during deposition of EBC on the substrate using an external burner and/or resistive electrical heating. Additionally, or alternatively, the as-deposited EBC may be heat treated using an external burner and/or resistive electrical heating. In some examples, the techniques of the disclosure are configured to increase or otherwise tailor the amount of crystalline phase in the EBC.

This application claims the benefit of U.S. Provisional Patent Application No. 62/876,450, filed Jul. 19, 2019, the entire content of which is incorporated herein by reference.

### TECHNICAL FIELD

The disclosure relates to techniques for forming coatings such as environmental barrier coatings using thermal spray deposition.

### BACKGROUND

Ceramic or ceramic matrix composite (CMC) materials may be useful in a variety of contexts where mechanical and thermal properties are important. For example, components of high temperature mechanical systems, such as gas turbine engines, may be made from ceramic or CMC materials. Ceramic or CMC materials may be resistant to high temperatures, but some ceramic or CMC materials may react with some elements and compounds present in the operating environment of high temperature mechanical systems, such as water vapor. Reaction with water vapor may result in the recession of the ceramic or CMC material. These reactions may damage the ceramic or CMC material and reduce mechanical properties of the ceramic or CMC material, which may reduce the useful lifetime of the component. Thus, in some examples, a ceramic or CMC material may be coated with an environmental barrier coating, which may reduce exposure of the substrate to elements and compounds present in the operating environment of high temperature mechanical systems.

### SUMMARY

In some examples, the disclosure describes a method that comprises depositing an environmental barrier coating (EBC) on a substrate via a thermal spray apparatus to form an as-deposited EBC; and heat treating the as-deposited EBC following the deposition of the as-deposited EBC on the substrate, wherein heat treating the as-deposited EBC includes at least one of heating the substrate via resistive electrical heating to heat the as-deposited EBC or heating the as-deposited EBC via an external burner to form a heat-treated EBC, and wherein the heat treatment is configured to increase a weight percent of crystalline phase in the heat-treated EBC compared to the as-deposited EBC.

In some examples, the disclosure describes a method that comprises depositing an environmental barrier coating (EBC) on a substrate via a thermal spray apparatus to form an as-deposited EBC; and heating the substrate to an elevated temperature at least one of before or during the deposition on the EBC on the substrate, wherein heating the substrate comprises at least one of heating the substrate via resistive electrical heating or heating a deposition surface of the substrate via an external burner.

In some examples, the disclosure describes a method that comprises depositing an environmental barrier coating (EBC) on a substrate via a thermal spray apparatus to form an as-deposited EBC; and heat treating the as-deposited EBC during and following the deposition of the as-deposited EBC on the substrate, wherein heat treating the as-deposited EBC includes at least one of heating the substrate via resistive electrical heating to heat the as-deposited EBC or heating the as-deposited EBC via an external burner to form a heat-treated EBC, and wherein the heat treatment is configured to increase a weight percent of crystalline phase in the heat-treated EBC compared to the as-deposited EBC.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic diagram illustrating an example system for heat treating an EBC on a substrate in accordance with an example of the disclosure.

FIG. 2 is a conceptual block diagram illustrating an example an example system in accordance with an example of the disclosure.

FIG. 3 is a flow diagram illustrating an example technique for forming an EBC on a substrate.

FIG. 4 is a flow diagram illustrating another example technique for forming EBC on a substrate.

FIG. 5 is a conceptual and schematic diagram illustrating an example article including an EBC on a substrate.

FIG. 6 is a conceptual and schematic diagram illustrating an example article including an EBC on a substrate.

FIGS. 7-10 are conceptual diagrams illustrating resistive electrical heating of various example articles.

### DETAILED DESCRIPTION

The disclosure describes systems and techniques for forming an environmental barrier coating (EBC) using thermal spray deposition, such as air plasma spraying. The EBC may be deposited on a substrate, such as a ceramic or CMC substrate, that serves as components of jet engines or other high temperature systems. Thermal spray systems may be used in a wide variety of industrial applications to coat such substrates with EBCs to modify or improve the properties of underlying substrate or component as a whole. Thermal spray systems may use heat generated electrically, by plasma, or by combustion to heat material injected in a plume, so that molten or softened material propelled by the plume contact the surface of the target. Upon impact, the molten or softened material adheres to the target surface, resulting in a coating.

EBCs may be an important contributor to the success of CMCs in a high temperature system. For example, the EBC may be configured to protect against oxidation, water vapor recession, and other deleterious reactions from damaging the structural CMC, e.g., during operation of the high temperature system. In some examples, EBCs may protect Si containing substrates such as SiC/SiC CMCs from water vapor attack.

In some examples, an EBC may contain single EBC layer or may be a multilayered structure, e.g., including a bond layer (e.g., a silicon bond layer or mullite bond layer) and one or more rare-earth silicate (e.g., rare earth disilicate) layers. In some examples, the layers of the EBC may be deposited using a thermal spraying process, such as, air plasma spraying, which may produce an amorphous structure within the coating, e.g., due to the high cooling rates/quenching of the particles upon impact with a substrate. For example, if rare earth silicate EBCs are deposited on unheated substrates via air plasma spraying (APS), the quench rate may be so high that the EBC deposits do not have time to crystalize and the EBC is amorphous in an as-sprayed state.

The resulting amorphous structure may change to a crystalline structure over time when subjected to higher temperatures, e.g., during operation of a high temperature system. An uncontrolled transition from amorphous to crystalline structure over time may result in volumetric changes in the layer or coating and, thus, internal stresses in the layer(s) (e.g., a rare-earth disilicate layer). In particular, in some examples, as the EBC structure changes from amorphous to crystalline, there may be decrease in the overall volume of the EBC structure. This may cause stress on the EBC as well as the silicon bond coat. Eventually, the stress may reach a threshold and cause a crack to initiate to relieve the stress state. For example, during service, the amorphous EBC may crystallize with attendant volume shrinkage, which may induce high tensile stresses that exceed the EBC cohesive strength and cause EBC cracking. The cracks open the paths ways for environmental attack from water vapor, calcium-aluminosilicate (CMAS) and sodium sulphates.

In some examples, an article including an EBC deposited on a ceramic or CMC substrate may be heat treated in a furnace following thermal spraying. The heat treatment take place at an elevated temperature (e.g., 1200 degrees Celsius (° C.) or greater) for an extended period of time (e.g., greater than 2 hours). The heat treatment may be configured to transition the amorphous phase of the EBC to a crystalline phase in a controlled manner. However, the heat treatment may increase the entire substrate to the elevated heat treatment temperature for an extended period of time, which may be undesirable. For example, for SiC/SiC composites made from low grade SiC fibers such as Hi-Nicalon and SiC/SiC composites made by Si melt infiltration, it may be desirable to not expose such composites above 1200° C. for an extended period of time to protect the fibers and the matrix from degradation. Additionally, such heat treatment may result in the entire EBC reaching the same elevated heat treatment temperature, which may prevent formation of crystalline phase gradients along the thickness of the EBC on the substrate. In other examples, to overcome the EBC cracking issue from its crystallization, an EBC may be sprayed on CMC substrates inside a furnace, e.g., maintained at or about 1200 degrees Celsius. Although such a technique may be effective to generate a crystalline EBC, it does not lend itself to volume production.

In accordance with examples of the disclosure, systems and techniques are described that include controlling the substrate and/or coating temperatures before, during and/or after deposition of an EBC, e.g., to increase or otherwise control the amount of crystalline phase in one or more layers of the EBC system. The crystalline phase of an EBC may be controlled to reduce internal stresses during operation of a coated component due to the amorphous phase to crystalline phase transition.

In some examples, the substrate may be heated before, during, and/or after deposition of the EBC by resistive electrical heating of the substrate. For example, a current may be conducted through the substrate, which acts as a resistor that converts the electrical energy into heat energy. The heat energy from the resistive electrical heating may be heat the substrate, e.g., to increase the temperature of the substrate at the deposition surface. In some examples, the EBC may be deposited on the heated substrate surface. Additionally, or alternatively, the substrate may be heated following the deposition of the EBC. The heat energy from the resistive electrical heating may be conducted through the substrate into the EBC to increase the temperature of the overlaying EBC. In some examples, the temperature of the EBC may be increased by the resistive electrical heating of the substrate in a manner that transitions amorphous phase in the as-deposited EBC to crystalline phase.

Additionally, or alternatively, the substrate and/or EBC may be heated via an external burner (e.g., an oxygen-fuel burner). For example, the flame of the external burner may be directed towards the deposition surface of the substrate prior to or during the EBC deposition on the substrate surface, e.g., to increase the temperature of the deposition surface. Additionally, or alternatively, the as-deposited EBC coating may be heat treated by heating the EBC using the external burner. For example, the flame may be directed towards the surface of the EBC on the surface of the substrate to heat the EBC. In some examples, the temperature of the EBC may be increased by burner heating of the EBC in a manner that transitions amorphous phase in the as-deposited EBC to crystalline phase.

The heating of the substrate and/or deposited EBC via resistive electrical heating and/or an external burner may allow for a transition from amorphous to crystalline phase in one or more layers of the deposited EBC, e.g., in a manner that minimizes or otherwise reduces the internal stresses in the layer(s) of the EBC system, e.g., that would otherwise be present during heating of the EBC system during operation of a jet engine including the coated component. For example, thermal sprayed rare earth silicates may effectively quench in an amorphous phase during rapid solidification on a cold substrate that is below the amorphous-crystalline transition temperature. Upon heating the coating past amorphous-crystalline transition temperature, two events may occur: 1) transformation from amorphous to crystalline atom structure, and 2) viscous flow of the amorphous coating prior to the phase transformation (may not occur if heating rate is too rapid). The combination of these events may act to resolve the residual stress. In some examples, the goal may be to have fully crystalline coatings (e.g., the one or more layers of the EBC system being substantially all crystalline phase with minimum, relatively low, or trace amounts of amorphous phase). In some examples, the one or more layers of an EBC system may have about 95 wt % crystallinity, e.g., following post-deposition heat treatment via an external burner and/or resistive electrical heating of the substrate and/or as a result of heating the substrate before and/or during the deposition of the EBC via resistive electrical heating and/or an external burner.

In some examples, when the one or more layers of an EBC system is sprayed onto a cold substrate, the coating locks in an amorphous microstructure. When the amorphous structure is heated, the coating transitions to a crystalline (lower energy state) microstructure. During this phase change, the overall volume decreases, causing a build-up of residual stress. If this stress is significant, it will crack the EBC and/or substrate. By controlling the post-deposition heat treatment, and/or temperature of deposition, the rate at which the stresses form may be controlled and/or the residual stress may be relaxed out. In some examples, the heat treatment temperature of a deposited coating and/or temperature of the substrate during deposition of the EBC may be controlled to obtain a relaxed EBC system, e.g., prior to employing a coated substrate in operation as part of a high temperature gas turbine engine.

In some examples, systems and techniques of the disclosure include pre-heating and/or in-situ heating of the substrate to a prescribed temperature prior to or during the deposition of the EBC. In such instances, the deposition surface of the substrate may be heated using resistive electrical heating and/or an external burner to the prescribed temperature, upon which the coating is applied. The coated substrate may undergo a controlled heat treatment by resistive electrical heating of the substrate and/or heating of the deposited EBC using the external burner, e.g., to enhance microstructure, crystallinity, and/or residual stress. In other examples, systems and techniques of this disclosure may include a post-coating heat treatment that is effective in controlling the crystalline structure of deposited layers even in the absence of pre-heating of a substrate and/or in-situ heating of the substrate during the deposition process.

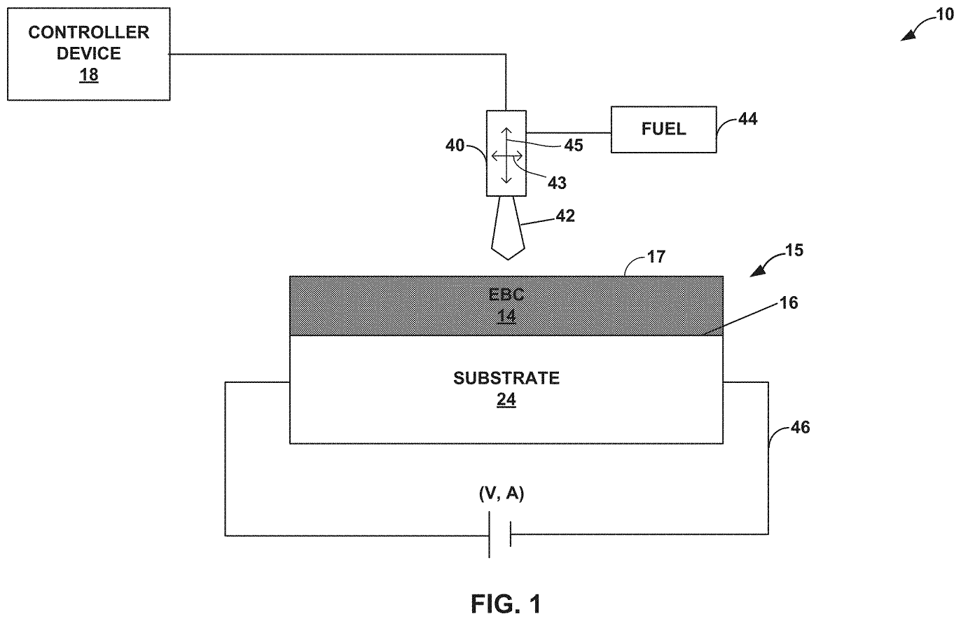

FIG. 1 is a conceptual and schematic diagram illustrating an example system 10 for heat treating an article 15 including an EBC 14 on substrate 24. The heat treatment may take place after EBC 14 has been deposited on substrate 24, e.g., using a thermal spray process. As shown, system 10 includes controller device 18, external burner 40, fuel source 44, and electric circuit 46. Although burner 40 is shown as a single burner in FIG. 1, in some examples, system 10 may include more than one burner. System 10 may be employed to heat EBC 14 via resistive electrical heating and/or by burner 40 in situ, e.g., within a deposition enclosure of a thermal spray device, such that substrate 24 is maintained in substantially the same position, same mount, or at least within a thermal spray device enclosure as when EBC 14 is applied by the thermal spray device. System 10 may be additionally or alternatively employed in a different location than the device or system used to apply EBC 14, e.g., in a different enclosure used for post deposition heat treatment.

As shown, article 15 includes EBC 14 is formed on deposition surface 16 of substrate 24. EBC 14 may include one or more layers formed on deposition surface 16 of substrate 24, e.g., using a thermal spray process such as air plasma spraying or the like. In some examples, article 15 may include a component of a gas turbine engine. For example, article 15 may include a part that forms a portion of a flow path structure, a seal segment, a blade track, an airfoil, a blade, a vane, a combustion chamber liner, or another portion of a gas turbine engine.

As described above, article 15 includes EBC 14 formed on substrate 24. EBC 14 may be a single layer or multi-layer coating, where each layer has substantially the same or different compositions. As used herein, “formed on” and “on” mean a layer or coating that is formed on top of another layer or coating, and encompasses both a first layer or coating formed immediately adjacent a second layer or coating and a first layer or coating formed on top of a second layer or coating with one or more intermediate layers or coatings present between the first and second layers or coatings. In contrast, “formed directly on” and “directly on” denote a layer or coating that is formed immediately adjacent another layer or coating, e.g., there are no intermediate layers or coatings.

Substrate 24 may include a material suitable for use in a high-temperature environment. In some examples, substrate 24 may include a ceramic or a ceramic matrix composite (CMC). Suitable ceramic materials, may include, for example, a silicon-containing ceramic, such as silica (SiO₂) and/or silicon carbide (SiC); silicon nitride (Si₃N₄); alumina (Al₂O₃); an aluminosilicate; a transition metal carbide (e.g., WC, Mo₂C, TiC); a silicide (e.g., MoSi₂, NbSi₂, TiSi₂); combinations thereof; or the like. In some examples in which substrate 24 includes a ceramic, the ceramic may be substantially homogeneous.

In examples in which substrate 24 includes a CMC, substrate 24 may include a matrix material and a reinforcement material. The matrix material may include, for example, silicon metal or a ceramic material, such as silicon carbide (SiC), silicon nitride (Si₃N₄), an aluminosilicate, silica (SiO₂), a transition metal carbide or silicide (e.g., WC, Mo₂C, TiC, MoSi₂, NbSi₂, TiSi₂), or another ceramic material. The CMC may further include a continuous or discontinuous reinforcement material. For example, the reinforcement material may include discontinuous whiskers, platelets, fibers, or particulates. Additionally, or alternatively, the reinforcement material may include a continuous monofilament or multifilament two-dimensional or three-dimensional weave, braid, fabric, or the like. In some examples, the reinforcement material may include carbon (C), silicon carbide (SiC), silicon nitride (Si₃N₄), an aluminosilicate, silica (SiO₂), a transition metal carbide or silicide (e.g. WC, Mo₂C, TiC, MoSi₂, NbSi₂, TiSi₂), or the like. Substrate 24 may include at least some electrically conductive material to enable resistive electrical heating, as described herein. As described above, in some examples, substrate 24 includes free silicon which may allow for resistive electrical heating of substrate 24 may conducting a current through substrate 24.

Substrate 24 may be manufactured using one or more techniques including, for example, chemical vapor deposition (CVD), chemical vapor infiltration (CVI), polymer impregnation and pyrolysis (PIP), slurry infiltration, melt infiltration (MI), combinations thereof, or other techniques.

EBC 14 may help protect underlying substrate 24 from chemical species present in the environment in which article 15 is used, such as, e.g., water vapor, calcia-magnesia-alumina-silicate (CMAS; a contaminant that may be present in intake gases of gas turbine engines), or the like. Similarly, the EBC may also be CMAS resistant, e.g., the EBC system itself may be resistant to damage caused by CMAS. Similarly, EBC 14 may also be CMAS resistant, e.g., the EBC system itself may be resistant to damage caused by CMAS. Additionally, in some examples, EBC 14 may also protect substrate 24 and provide for other functions besides that of an EBC, e.g., by functioning as a thermal barrier coating (TBC), abradable coating, erosion resistant coating, and/or the like.

Although not directly shown in FIG. 1, in some examples, article 15 may include a bond coat on substrate 24, e.g., where the bond layer is directly on substrate 24 and one or more layers of EBC 14 are directly on the bond layer. The bond layer may increase the adhesion between substrate 24 and the one or more additional layers of EBC 14. In some examples, the bond coat has a thickness of approximately 25 microns to approximately 250 microns, although other thicknesses are contemplated. In examples in which substrate 24 includes a ceramic or CMC, the bond coat may include a ceramic or another material that is compatible with the material from which substrate 24 is formed. For example, the bond coat may include mullite (aluminum silicate, Al₆Si₂O₁₃), silicon metal or alloy, silica, a silicide, or the like. The bond coat may further include other elements, such as a rare earth silicate including a silicate of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), and/or scandium (Sc).

EBC 14 may include one or more EBC layers, which may be configured to help protect substrate 24 against deleterious environmental species, such as CMAS and/or water vapor. The layer(s) of EBC 14 may include at least one of a rare-earth oxide, a rare-earth silicate, an aluminosilicate, or an alkaline earth aluminosilicate. For example, the layer(s) of EBC 14 may include mullite, barium strontium aluminosilicate (BSAS), barium aluminosilicate (BAS), strontium aluminosilicate (SAS), at least one rare-earth oxide, at least one rare-earth monosilicate (RE₂SiO₅, where RE is a rare-earth element), at least one rare-earth disilicate (RE₂Si₂O₇, where RE is a rare-earth element), or combinations thereof. The rare-earth element in the at least one rare-earth oxide, the at least one rare-earth monosilicate, or the at least one rare-earth disilicate may include at least one of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), or scandium (Sc). EBC 14 may be any suitable thickness. For example, EBC 14 may be about 0.005 inches (about 127 micrometers) to about 0.100 inches (about 2540 micrometers). Other thicknesses are contemplated.

In one example, EBC 14 includes a first (inner) layer that includes RE disilicate and a second (outer) layer that includes RE monosilicate or RE disilicate plus RE monosilicate.

In some examples, the layer(s) of EBC 14 additionally and optionally may include at least one additive, such as at least one of silica, a rare earth oxide, alumina, an aluminosilicate, an alkali metal oxide, an alkaline earth metal oxide, an alkali metal aluminosilicate, an alkaline earth aluminosilicate, TiO₂, Ta₂O₅, HfSiO₄, or the like. The additive may be added to the EBC to modify one or more desired properties of the EBC. For example, the additive components may increase or decrease the reaction rate of the EBC with calcia-magnesia-alumina-silicate (CMAS; a contaminant that may be present in intake gases of gas turbine engines), may modify the viscosity of the reaction product from the reaction of CMAS and constituent(s) of the EBC, may increase adhesion of the EBC to the bond coat, may increase the chemical stability of the EBC, or the like.

System 10 may be used to perform a post-deposition heat treatment of EBC 14 on substrate 24. During the post-deposition heat treatment, system 10 may elevate the temperature of EBC 14 for a period of time. The elevated temperature and the period of time of the heat treatment may be selected to transition amorphous phase within one or more layers of the as-deposited EBC 14 to crystalline phase, e.g., such that the heated treated EBC 14 includes a greater concentration of crystalline phase compared to that of the as-deposited EBC 14.

System 10 includes external burner 40. In the example of FIG. 1, burner 40 is configured to heat EBC 14 on substrate 24, e.g., following the deposition of EBC 14 via a thermal spray process. Burner 40 generates flame 42 by igniting and combusting fuel 44 mixed with an oxidizer (e.g., ambient air or oxygen). Flame 42 is directed at EBC 14, e.g., at outer surface 17 of EBC 14, to heat EBC 14 during a post deposition heat treatment. Flame 42 may be directed out of a nozzle of burner 40.

Any suitable burner 40 and fuel 44 may be used. In some examples, burner 40 is an oxygen-gas/fuel burner. In some examples, burner 40 may be an acetylene torch, e.g., the same or similar to that used for welding and/or cutting. Burner 40 may employ a gas mixture and at least one nozzle from which flame 42 extends. In some examples, burner 40 includes multiple nozzles, e.g., that are distributed at different positions around substrate 24. Fuel 44 may include propane, propylene, acetylene, butane or mixtures thereof. The gas used for the burner may be at least one of natural gas or hydrogen. Burner 40 may be relatively easy to set and may be flexible to various substrate 24 geometries.

Controller device 18 may control the operation of burner 40 to achieve the desired heat treatment temperature of EBC 14. In some examples, the temperature of EBC 14 heated by burner 40 may be tailored or otherwise controlled by controlling the temperature of flame 42 of burner 40. The temperature of flame 42 and the heating of EBC 14 may be controlled by selecting a fuel type, nozzle size, nozzle geometry or other design, standoff distance (e.g., the distance from the nozzle of burner 40 to the outer surface 17 of EBC 14), mixture ratio (e.g., the flow ratio of oxygen to gas/fuel), and/or fuel flow rate. In some examples, the temperature of flame 42 may be greater than 1900° C., such as, about 1900° C. to about 2000° C., about 1900° C. to about 3500° C., or about 2000° C. to about 3500° C. The standoff distance may be about 0.1 inches to about 25 inches. Other values are contemplated. Each of the parameters may be selected to provide for the desired heating of EBC 14.

In some examples, for production, a series of burners such as burner 40 may be employed to define a preheating section and a coating section, e.g., to improve production efficiency. As will be described herein, in some examples, burner 40 may be set stationary and heat the component (e.g., EBC 14 and/or substrate 24 (e.g., in the case of preheating)) constantly at fixed locations and/or be set to move along with the thermal deposition gun, for example, on either or both sides. The heating segments may include preheating, heating during coating, post-deposition heating, or may combine some or all heating segments.

Burner 40 and article 15 may be configured to move relative to each other during the heating of EBC 14 so that flame 42 may be moved relative to EBC 14. For example, as shown in FIG. 1, burner 40 may be moved in direction 43 to move flame 42 from “side to side” relative to EBC 14 as well as moved in direction 45 to move flame 42 “up and down” relative to the outer surface 17 of EBC 14. Controller device 18 may control the movement of burner 40 to achieve the desired heating of EBC 14 in the manner described herein. While FIG. 1 shows burner 40 being moveable, EBC 14 may additionally or alternatively be moveable to provide for relative movement between EBC 14 and flame 42.

EBC 14 may be heat treated by burner 40 to increase or otherwise control the concentration of crystalline phase within one or more layers of EBC 14. As will be described further below, in some examples, controller device 18 may control burner 40 to heat EBC at or above a crystalline transition temperature of one or more layers of EBC 14 such that at least some of the amorphous phase within EBC 14 is transitioned to crystalline phase as a result of the heat treatment by burner 40. In some examples, based on the location of flame 42 adjacent to outer surface 17 of EBC 14, burner may be configured to generate a temperature gradient along the thickness of EBC 14. For example, burner 40, under the control of controller device 18, may heat EBC 14 using flame 42 such that a temperature of EBC 14 nearer outer surface 17 is greater than a temperature of EBC 14 nearer deposition surface 16 of substrate 24. In this manner, a crystalline phase concentration gradient may be provided by the heat treatment along the thickness of EBC 14, e.g., with more crystalline phase nearer the outer surface 17 of EBC 14 compared to nearer deposition surface 16 of substrate 24. In other examples, controller device 18 controls burner 40 to heat EBC 14 to approximately the same temperature throughout the thickness of EBC 14. In some examples, controller device 18 controls burner 40 to heat EBC 14 such that a temperature gradient is formed in the “side to side” direction (e.g., length and/or width), e.g., in addition to, or as an alternative to, a temperature gradient along the thickness of EBC 14.

System 10 is configured to additionally or alternatively heat EBC 14 and/or substrate 24, e.g., following deposition on substrate 24, using resistive electrical heating of substrate 24. For example, as show in FIG. 1, system 10 includes electric circuit 46. Electric circuit 46 is configured to conduct a current through substrate 24, which may be electrically conductive. In some examples, substrate 24 may be a silicon carbide (SiC) CMC or other type CMC made by melt infiltration. In such examples, substrate 24 may include a relatively small amount of free silicon (e.g., less than about 10 weight percent, such as, about 1 weight percent to about 10 weight percent, or about 1 weight percent to about 3 weight percent free silicon). The free silicon may be present due to an incomplete reaction of Si with C. In such an example, substrate 24 may conduct a current such that substrate 24 is heated by the electric current. For example, the resistance of substrate 24 converts the electrical energy to heat energy, which heat substrate 24.

By heating substrate 24 via resistive electrical heating, heat from substrate 24 may be conducted to EBC 14 across the interface between EBC 14 and substrate 24 at deposition surface 16. The heat from substrate 24 into EBC 14 may increase the temperature of EBC 14. Controller device 18 may controller circuit 46 to control the heating of substrate 24 and, as a result, control the heating of EBC 14. For example, controller device 18 may be configured to control the amount of current conducted through substrate 24 by circuit 46 to control the heating of substrate 24. In some examples, a current of at least 1 Ampere (A), such as, about 1 A to about 10 A, may be conducted through substrate 24. In this manner, the temperature of EBC 14 may be controlled during the heat treatment process. In some examples, substrate 24 may be heated to a temperature of at least about 900° C., such about 900° C. to about 1000° C., about 900° C. to 1100° C., or about 1000° C. to about 1100° C., but less than about 1250° C., by resistive electrical heating. Additionally, or alternatively, the heating of substrate 24 may be controlled by the placement of the electrical connections connecting substrate 24 to circuit 46.

In some examples, the placement of electrical connections and/or the level of current conducted through substrate 24 may allow for a temperature gradient to be defined within substrate 24 by the resistive electrical heating. For example, an electrical resistance heating flow path may be generated that heats of a portion of substrate 24 nearer deposition surface 16 more than another portion of substrate 24 further from deposition surface 16. In this manner, not all of substrate 24 is subjected to the same level of heating and allows the temperature of substrate 24 to be at a greater temperature nearer deposition surface 16 compared to the temperature of substrate further from deposition surface 16. Such heating may be preferred compared to heat treatment in which the entire substrate 24 is heated to an elevated temperature (e.g. at or above 1200° C.) for an extended period of time, e.g., within a furnace.

EBC 14 may be heat treated by resistive electrical heating of substrate 24 to increase or otherwise control the concentration of crystalline phase within one or more layers of EBC 14. As will be described further below, in some examples, controller device 18 may control electric circuit 46 to heat EBC 14 at or above a crystalline transition temperature of one or more layers of EBC 14 such that at least some of the amorphous phase within EBC 14 is transitioned to crystalline phase as a result of the heat treatment by burner 40. In some examples, the resistive electrical heating of substrate 24 may be configured to generate a temperature gradient along the thickness of EBC 14. For example, controller device 18 may control circuit 46 to heat EBC 14 via substrate 24 such that a temperature of EBC 14 nearer deposition surface 16 is greater than a temperature of EBC 14 nearer outer surface 17 of EBC 14. In this manner, a crystalline phase concentration gradient may be provided by the heat treatment along the thickness of EBC 14, e.g., with more crystalline phase in EBC 14 nearer the deposition surface 16 compared to nearer outer surface 17. In other examples, controller device 18 controls circuit 46 to heat EBC 14 to approximately the same temperature throughout the thickness of EBC 14.

Computing device 18 may be configured as a control device that controls system 10 to operate in the manner described herein. For example, computing device 18 may be configured to control the temperature of substrate 24 and EBC 14 using burner 40 and/or electric circuit 46, as described herein. Computing device 18 may be communicatively coupled to at least one of burner 40 or electric circuit 46 using respective communication connections. Such connections may be wireless and/or wired connections. While computing device 18 is shown as a single device, in other examples, computing device 18 may be more than one computing device, such as, e.g., where each of burner 40 and circuit 46 are controlled by different computing devices.

Computing device 18 may include, for example, a desktop computer, a laptop computer, a workstation, a server, a mainframe, a cloud computing system, or the like. Computing device 18 may include or may be one or more processors or processing circuitry, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” and “processing circuitry” as used herein may refer to any of the foregoing structure or any other structure suitable for implementation of the techniques described herein. In addition, in some examples, the functionality of computing device 18 may be provided within dedicated hardware and/or software modules.

As will be described further below, system 10 may be configured to heat treat EBC 14 following deposition onto surface 16 of substrate 24 using one or both of burner 40 and resistive electrical heating using circuit 46. In some examples, EBC 14 may be heat treated using both burner 40 and resistive electrical heating at substantially the same time and/or sequentially with or with overlap (e.g., heated first with burner 40 followed by the resistive electrical heating of substrate 24, or vice versa). In some examples, the post deposition heat treatment of EBC 14 may be used in combination with a pre-deposition heating of substrate 24, e.g., by heating substrate 24 with burner 40 and/or resistive electrical heating via circuit 46 before and/or during the deposition of one or more layers of EBC 14.

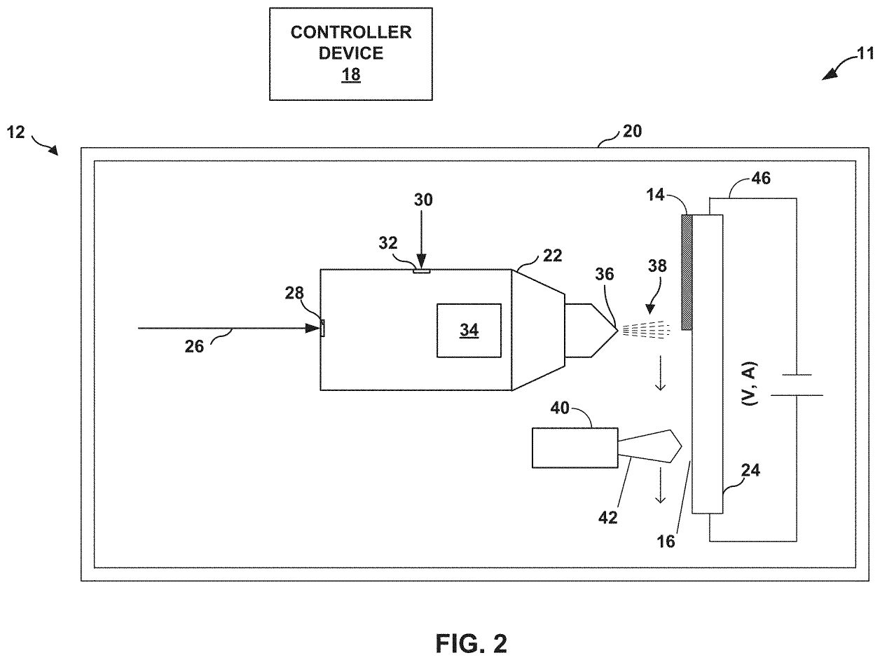

FIG. 2 is a conceptual and schematic diagram illustrating an example system 11 for depositing EBC 14 on substrate 24 using a thermal spray process that includes controlled heating before, during, and/or after the deposition of EBC 14 on deposition surface 16 of substrate 24. As shown, system 11 includes thermal spray device 12, controller device 18, burner 40 and electric circuit 46. Controller device 18, burner 40, and electric circuit 46 may be substantially the same as described above with regard to system 10 of FIG. 1. In addition to, or as an alternative to, heating EBC 14 following deposition on substrate 24, burner 40 and/or electric circuit 46 may be controlled by controller device 18 to heat substrate 24 before and/or during the deposition of EBC 14 using thermal spray device 12.

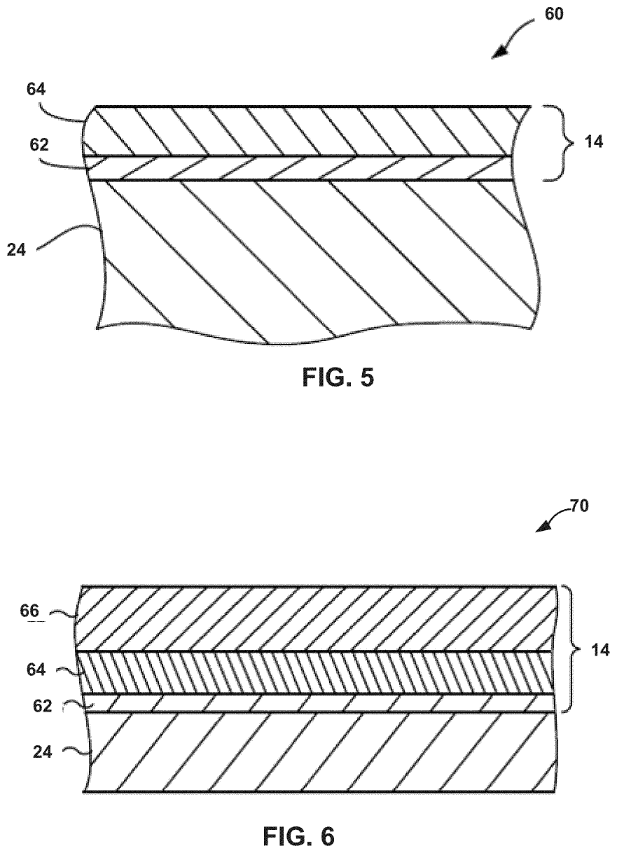

Thermal spray device 12 may be configured to deposit one or more layers of a coating system on a substrate to form a coated article, such as article 15 in FIG. 1, article 60 in FIG. 5 or article 70 in FIG. 6 which includes EBC 14 on substrate 24, using a thermal spray process. Example thermal spray processes may include suspension plasma spray, low pressure plasma spraying, plasma spray physical vapor deposition, and air plasma spraying. In one example, thermal spray device 12 may be configured to deposit the one or more layers of a coating system using a plasma spray process, such as an air plasma spray process. In an air plasma spray process, the plasma is sprayed in an air environment, e.g., as compared to a spraying in a vacuum or an inert gas (e.g., argon) environment. Air plasma spraying may be amenable to automation for the application of coatings onto complex surfaces. The deposition rates may be very economical compared to other processes such as HVOF.

In one example, system 11 may be configured to form an article which includes EBC 14 deposited on substrate 24. For example, system 11 may be configured to deposit one or more layers of EBC 14 on substrate 24 using thermal spray device 12, e.g., by air plasma spraying or other thermal spray deposition process. As will be described further below, the heating of substrate 24 before and/or during the deposition of EBC 14 by device 12 may be controlled by computing device 18 so that substrate 24 is at an elevated temperature (e.g., a temperature at or above the crystallization temperature of EBC system 68) before, during, and/or after the deposition of EBC 14. In some examples, the heating of substrate 24 may provide for an increase in the amount of crystalline phase to amorphous phase in EBC 14, e.g., as compared to an article in which the EBC system is deposited by thermal spray device 12 without heating of substrate 24.

Thermal spray system 12 includes components such as enclosure 20 and a thermal spray gun 22. Enclosure 20 encloses some components of thermal spray system 12, including, for example, thermal spray gun 22. In some examples, enclosure 20 substantially completely surrounds thermal spray gun 22 and encloses an atmosphere. The atmosphere may include, for example, air, an inert atmosphere, a vacuum, or the like. In some examples, the atmosphere may be selected based on the type (e.g., composition) of coating being applied using thermal spray system 12. Enclosure 20 also encloses a spray target 24.

Spray target 24 (also referred to as substrate 24) includes a substrate to be coated using thermal spray system 12. In some examples, spray target 24 may include, for example, a substrate on which a bond coat, a primer coat, a hard coat, a wear-resistant coating, a thermal barrier coating, an EBC system, or the like is to be deposited. Spray target 24 may include a substrate or body of any regular or irregular shape, geometry or configuration. In some examples, spray target 24 may include metal, plastic, glass, or the like. Spray target 24 may be a component used in any one or more mechanical systems, including, for example, a high temperature mechanical system such as a gas turbine engine.

Thermal spray gun 22 is coupled to a gas feed line 26 via gas inlet port 28, is coupled to a spray material feed line 30 via material inlet port 32, and includes or is coupled to an energy source 124. Gas feed line 26 provides a gas flow to gas inlet port 28 of thermal spray gun 22. Depending upon the type of thermal spray process being performed, the gas flow may be a carrier gas for the coating material, may be a fuel that is ignited to at least partially melt the coating material, or both. Gas feed line 26 may be coupled to a gas source (not shown) that is external to enclosure 20.

Thermal spray gun 22 also includes a material inlet port 32, which is coupled to spray material feed line 30. Material feed line 30 may be coupled to a material source (not shown) that is located external to enclosure 20. Coating material may be fed through material feed line 30 in powder form, and may mix with gas from gas feed line 26 within thermal spray gun 22. The composition of the coating material may be based upon the composition of the coating to be deposited on spray target 24, and may include, for example, a metal, an alloy, a ceramic, or the like.

Thermal spray gun 22 also includes energy source 34. Energy source 34 provides energy to at least partially melt the coating material from coating material provided through material inlet port 32. In some examples, energy source 34 includes a plasma electrode, which may energize gas provided through gas feed line 26 to form a plasma. In other examples, energy source 34 includes an electrode that ignites gas provided through gas feed line 26.

As shown in FIG. 2, an exit flow stream 38 exits outlet 36 of thermal spray gun 22. In some examples, outlet 36 includes a spray gun nozzle. Exit flow stream 38 may include at least partially melted coating material carried by a carrier gas. Outlet 36 may be configured and positioned to direct the at least partially melted coating material at spray target 24.

Computing device 18 may be configured to control operation of one or more components of thermal spray system 12 automatically or under control of a user. For example, computing device 18 may be configured to control operation of thermal spray gun 22, gas feed line 26 (and the source of gas to gas feed line 26), material feed line 30 (and the source of material to material feed line 30), and the like. For example, computing device 18 may be configured to control at least one of a temperature, a pressure, a mass flow rate, a volumetric flow rate, a molecular flow rate, a molar flow rate, a composition or a concentration, of a flow stream flowing through thermal spray system 12, for instance, of gas flowing through gas feed line 26, or of exit flow stream 38, or of material flowing through material feed line 30.

In some examples, thermal spray device may include a stage or other component configured to selectively position and restrain substrate 24 in place during formation of EBC 14. In some examples, the stage or other component is movable relative to thermal spray gun 22. For example, in this manner, substrate 24 may be translatable and/or rotatable along at least one axis to position substrate 24 relative to plasma spray gun 22. Similarly, in some examples, plasma spray gun 22 may be movable relative to substrate 24 to position plasma spray device 20 relative to substrate 24.

In some examples, the temperature within enclosure 20 may be controlled by computing device 18. For example, computing device 18 may elevate the temperature in enclosure 20 above room temperature during the thermal deposition of EBC system 68. In other examples, enclosure 20 is not heated.

As described herein, system 11 may be configured to heat substrate 24 before and/or during the thermal spray deposition of EBC 14 onto deposition surface 16. For example, controller device 18 may control burner 40 such that flame 42 of burner 40 is directed at deposition surface 16 before and/or during the deposition of the material of EBC 14 from thermal spray gun 22 such that surface 16 is heated to an elevated temperature when the material is deposited. Additionally, or alternatively, controller device 18 may control electric circuit 46 to conduct a current through substrate 24 to electrically heat substrate 24 to an elevated temperature before and/or during the deposition of the material of EBC 14 from thermal spray gun 22. Burner 40 and electric circuit 46 may operate to heat substrate 24 before and/or during the deposition of EBC 14 in the same manner as described above with regard to FIG. 1 for the post-deposition heat treatment of EBC 14.

In some examples, deposition surface 16 may be heated to a temperature of at least approximately 900° C. such as, e.g., from about 900° C. to about 1000° C., about 900° C. to about 1100° C., or about 1000° C. to about 1100° C. Deposition surface 16 of substrate 24 may be at the elevated temperature when the material of EBC 14 is deposited by thermal spray gun 22. By controlling the temperature of deposition surface 16 of substrate 24 during thermal spray deposition, the amount of crystalline phase of the deposited layer(s) of EBC 14 may be controlled. For example, the weight percent of crystalline phase in deposited layer(s) of EBC 14 may be increased compared to instances in which substrate heating is not employed. In some examples, increasing the weight percent of crystalline phase reduces the internal stresses resulting from transition from amorphous phase to crystal phase during operation of a high temperature system, as less material is available to transition. An increase in crystalline phase the layer(s) of the deposited EBC 14 may promote increased adhesion between the deposited EBC 14 and underlying substrate 24.

In some examples, burner 40 is mounted or otherwise coupled to thermal spray gun 22 of system 11. In such examples, burner 40 may be moved as thermal spray gun 22 is moved relative to deposition surface 16. In other examples, burner 40 may be moveable independent of thermal spray gun 22.

In some examples, computing device 18 may employ one or more temperature sensors to monitor the temperature of enclosure 20 to use as feedback to control the temperature of enclosure 20, substrate 24 (e.g., temperature of surface 16), and/or EBC 14. In some examples, a temperature sensor may directly monitor the temperature of the deposition surface 16 of substrate 24 and/or EBC 14 to use as a feedback to control the temperature of enclosure 20, surface 16 of substrate 24, and/or EBC 14. Computing device 18 may control the temperature to maintain a surface temperature of surface 16 of substrate 24 conducive to the production of crystalline coatings. In some examples, computing device 18 may control the temperature of surface 16 of substrate 24 to be about 900° C. or greater, such as, about 900° C. to about 1100° C., or about 1000° C. or greater. In some examples, the method of control may be a line of site, non-contact surface measurement, e.g., given that the part may be in motion while coating.

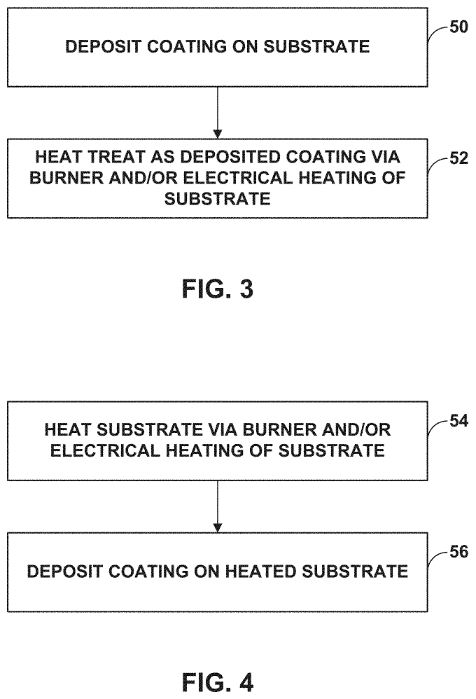

FIG. 3 is a flow diagram illustrating an example technique for forming a coating that includes an environmental barrier coating on a substrate using a thermal spray process. The technique of FIG. 3 will be described with respect to system 10 and article 15 of FIG. 1 for ease of description only. A person having ordinary skill in the art will recognize and appreciate that the technique of FIG. 3 may be implemented using systems other than system 10 of FIG. 1, such as system 11, may be used to form articles other than article 15 of FIG. 1.

As shown in FIG. 3, the one or more layers of EBC 14 may be deposited on substrate 24 by thermal spraying (e.g., air plasma spraying or other thermal spray process using thermal spray device 12 of FIG. 2) (50). As described above, thermal spray device 12 may deposit the one or more layers of EBC 14 under the control of computing device 18.

When EBC 14 is deposited, the layer(s) of EBC 14 may have a relatively high amorphous phase concentration, e.g., due to the high cooling rates/quenching of the particles upon impact with substrate 24. For example, the layer(s) of EBC 14 may have an amorphous phase of at least about 85 wt %. Conversely, the layer(s) of EBC 14 may have a crystalline phase of less than about 15 wt %. As noted above, without a post-deposition heat treatment, the amorphous phase may change to a crystalline structure over time when subjected to higher temperatures, e.g., during operation of a jet engine. An uncontrolled transition from amorphous to crystalline structure with time may also result in volumetric changes and, thus, internal stresses in the layer(s).

In accordance with examples of the disclosure, EBC 14 may be heat treated following deposition of EBC 14 on substrate 24 using burner 40 and/or resistive electrical heating of substrate 24 by circuit 46 as describe above (52). In some examples, the post-deposition heat treatment may take place before or after article 15 cools to room temperature following deposition. The post-deposition heat treatment temperature and duration may be controlled by computing device 18 and may be selected to increase the crystalline phase concentration of EBC 14 on substrate 24. For example, one or more layers of EBC 14 may be heated by burner 40 and/or resistive electrical heating to a treatment temperature of at or above the crystalline temperature of the layer(s) of EBC 14.

EBC 14 may be at the heat treatment temperature for a duration of time such that EBC 14 reaches a temperature at or above the crystalline phase temperature of the one or more layers of EBC 14. EBC 14 may be heated by burner 40 and/or resistive electrical heating of substrate 24 such that EBC 14 reaches a temperature at or above the temperature of the one or more layers of EBC 14 at which the amorphous phase transitions to a crystalline phase. In some examples, depending on the composition of the layer(s), the layer(s) of EBC 14 may have a temperature of at least about 850 degrees C., such as, e.g., about 850 degrees C. to about 1400 degrees C., about 900 degrees C. to about 1400 degrees C., about 850 degrees C. to about 1100 degrees C., about 1000 degrees C. to about 1200 degrees C., or about 900degrees C. to about 1100 degrees C., and less than about 1400 degrees C. during the post-deposition heat treatment. EBC 14 may be heated for a suitable amount of time to provide for a desired amount of crystalline phase in EBC 14. In some examples, the heat treatment duration may be at least about 1 hour (hr), such as about 1 hr to about 5 hrs. Values other than that described above are contemplated.

In some examples, EBC 14 may have an amorphous phase of less than about 50 wt % following the heat treatment describe above. In some examples, EBC 14 may have a crystalline phase of greater than about 50 wt %, such as, e.g., greater than about 60 wt %, greater than about 70 wt %, greater than about 80 wt %, greater than about 90 wt %, greater than about 95 wt %, greater than about 96 wt %, less than about 96 wt %, less than 100 wt %, about 50 wt % and less than 100 wt %, or substantially all crystalline phase following the heat treatment describe above. In some examples, the remainder of EBC 14 may be amorphous phase. In some examples, the amorphous phase content of the layer(s) of EBC 14 may be decreased compared to an article such as article 15 that does not undergo the described post-deposition heat treatment. In some examples, the crystalline phase content of the layer(s) of

EBC 14 may be increased by compared to an article such as article 15 that does not undergo the described post-deposition heat treatment. Other values are contemplated.

In some examples, to heat treat EBC 14, burner 40 may be employed to heat EBC 14 from outer surface 17 of EBC 14 while resistive electrical heating via electric circuit 46 may be employed to heat EBC 14 from deposition surface 16 of substrate 24. In some examples, burner 40 may heat EBC 14 at the same time as electric circuit 46 heat substrate 24 via resistive electrical heating. In other examples, only burner 40 may heat EBC 14 or only electric circuit 46 may heat EBC 14. In some examples, burner 40 and electric circuit 46 may heat EBC 14 at different times (e.g., one after another).

In some examples, burner 40 and/or circuit 46 may be operated by controller device 18 to generate a temperature gradient within EBC 14 (e.g., a gradient along the thickness of EBC 14). For example, since the resistive electrical heating of EBC 14 using electrical circuit 46 conducts heat into EBC 14 through substrate 24, controller device 18 may control electrical circuit 46 to heat substrate such that the temperature of EBC 14 nearer substrate 24 is greater than the temperature further from substrate 24. Likewise, since burner 40 heats EBC 14 from adjacent to outer surface 17, controller device 18 may control burner 40 to heat EBC 14 such that the temperature of EBC 14 nearer outer surface 17 is greater than the temperature further from outer surface 17. In examples in which EBC 14 include multiple layers, the temperature gradient may be configured to create a hard/crystalline top coating layer with a compliant amorphous bottom layer or a hard/crystalline layer nearer outer surface 17 of the coating and a compliant amorphous layer nearer substrate 24. Likewise, the temperature gradient may be configured to create such a crystalline/amorphous phase gradient along the thickness of a single layer of EBC 14. In some examples, the temperature gradient along the thickness of EBC 14 may define a temperature difference from outer surface 17 to the adjacent to deposition surface 16 of, e.g., approximately 200° C. or greater.

In some examples, in order to achieve and control desired temperature(s), system 10 may be configured to monitor the temperature of EBC 14 and/or substrate 24 using one or more suitable temperature sensors (e.g., thermocouples) located to accurately measure temperature (e.g., in substantially real-time) during the described techniques. In some examples, such components may be thermocoupled during process development trials to confirm that the desired heating/cooling rates are as expected, with the measured temperatures used for control afterwards.

FIG. 4 is a flow diagram illustrating another example technique for forming a coating that includes an environmental barrier coating on a substrate using a thermal spray process. The technique of FIG. 4 will be described with respect to system 11, EBC 14, and substrate 24 of FIG. 2. A person having ordinary skill in the art will recognize and appreciate that the technique of FIG. 4 may be implemented using systems other than system 11 of FIG. 2, may be used to form articles other than article 15, or both.

As shown in FIG. 4, controller device 18 may control burner 40 and/or electric circuit 46 to heat substrate 24 to an elevated temperature (54). Once deposition surface 16 reaches the desired temperature during the heating process, computing device 18 may control thermal spray device 22 and associated components of thermal spray system 10 to deposit one or more layers of EBC 14 on substrate 24 to form article 15. The one or more layers of EBC system 68 may be deposited on the heated substrate 24 by thermal spraying (e.g., air plasma spraying) using thermal spray device 12 (56). Substrate 24 may be heated prior to and/or during the deposition of EBC 14 on deposition surface 24.

In some examples, as result of the heating by burner 40 and/or electric circuit 46, surface 16 of substrate 24 may have a temperature of about 900° C. to about 1000° C., such as, about 900° C. or greater or about 900° C. to about 1200° C. when the material of EBC 14 is first deposited by thermal spray device 12. In cases in which substrate 24 is pre-heated, the time between the heating of substrate 14 and the initial thermal spraying may be relatively short to prevent substantially cooling of substrate 24 from that of the pre-heated temperature.

By elevating the temperature of deposition surface 16 via heating of substrate 24, the amount of crystalline phase in the deposited layer(s) may be increased (e.g., compared to instances in which surface 16 is not heated) or otherwise tailored. For example, when a particle is sprayed as a plasma from spray gun 22, the particle may be in an amorphous phase in air. If the particle hits a relatively cold surface, the particle solidifies relatively quickly, trapping it in the amorphous state. Conversely, if the substrate is relatively hot (e.g., via backside heating), then the particle has time to crystallize (e.g., which is a preferred lower energy state). This may also give the particle the opportunity to stay somewhat fluid, allowing for better infiltration and fewer pores.

The amount (e.g., weight percent) of crystalline phase in the one or more deposited layers may be more than that of similar layers deposited using the same process but without heating of substrate 24 as described herein. As noted above, without heating substrate 24, EBC 14 may have relatively high amount of amorphous phase. The amorphous phase may change to a crystalline structure over time when subjected to higher temperatures, e.g., during operation of a jet engine. An uncontrolled transition from amorphous to crystalline structure with time may also result in volumetric changes and, thus, internal stresses in the layer(s). By heating substrate 24, the amount of amorphous phased in EBC 14 may be decreased and the amount of crystalline phase may be increased. In some examples, the one or more deposited layers may have a crystalline phase of greater than about 50 wt %, such as, greater than about 60 wt %, greater than about 70 wt %, greater than about 80 wt %, greater than about 90 wt %, about 50 wt % to about 96 wt % or greater than about 96 wt % or about 100 wt %. The remainder of the layer composition may be amorphous phase in some examples. Other values are contemplated.

In some examples, article 15 may undergo an optional post-deposition heat treatment after the one or more layers of EBC 14 are deposited (56). For instance, in some examples, when EBC 14 is deposited, the layer(s) of EBC 14 may still have an undesirable amount of amorphous phase in the one or more layers, e.g., due to the high cooling rates/quenching of the particles upon impact with substrate 24. As such, in some examples, following deposition of EBC 14 on substrate 24, article 66 may be heat treated as described above with regard to FIG. 3 and/or may be heat treated using other techniques, e.g., within a furnace. In some examples, the post-deposition heat treatment may take place before or after article 15 cools to room temperature following deposition. The post-deposition heat treatment temperature and duration may be controlled by computing device 18 and may be selected to increase the crystalline phase concentration of EBC 14 on substrate 24, e.g., compared to that of the as-deposited layer from the thermal spraying. For example, burner 40 and/or electric circuit 46 may heat EBC 14 to a heat treatment temperature of at or above the crystalline transition temperature (e.g., the temperature of the transition between amorphous phase and crystalline phase and/or temperature of the transition between different crystalline phases) of the layer(s) of EBC 14. Additionally, or alternatively, the post-deposition heat treatment may reduce the porosity of one or more layer of EBC system 68.

In the example technique of FIGS. 3 and 4, the electric current and voltage for the resistive electrical heating of substrate 24 may be selected specifically for the geometry of the CMC component defined by substrate 24 and coated surface 16, the desired surface 16 temperature needed to achieve a crystalline EBC 14, and the chemical composition (electrical resistance) of substrate 24. The electrical connectors of circuit 46 may also be designed in such a way to control the distribution and magnitude of the temperature field within substrate 24 and/or EBC 14.

While examples of the disclosure are primarily described with regard to controlling the concentrate of crystalline phase of EBC 14, such techniques may also be employed to increase or otherwise control the density of EBC 14, lower residual stresses and/or increase coating bond strength.

In some examples, the temperature of surface 16 of substrate 24 during the deposition of the one or more layers of EBC 14 may be selected to control a porosity in the deposited layer(s) of EBC 14. For example, the porosity of the one or more deposited layers may be lower than that of similar layers deposited using the same process but without heating of substrate 24 as described herein. In some examples, the temperature of surface 16 during deposition may be selected to provide the one or more layers of EBC 14 with a porosity of, e.g., lower than about 10%, such as, about 1% to about 3%. An EBC system with a relatively low porosity (e.g., lower than about 3%) may be preferred as it may result in improved protection of substrate 24 from the environment during high temperature operation.

Similarly, in some examples, the temperature of EBC 14 during a post-deposition heat treatment of the one or more layers of EBC 14 may be selected to control a porosity in the layer(s) of EBC 14. For example, the porosity of the one or more deposited layers of EBC 14 following the heat treatment may be greater than that of similar layers deposited using the same process but without a post deposition heat treatment as described herein. In some examples, the temperature of EBC 14 during the post-deposition heat treatment may be selected to provide the one or more layers of EBC 14 with a porosity of, e.g., less than about 10%, such as, about 1% to about 3%. An EBC system with a relatively low porosity (e.g., less than about 3%) may be preferred as it may result in improved protection of substrate 24 from the environment during high temperature operation.

FIG. 5 is a conceptual schematic diagram illustrating another example article 60 that may be formed using the techniques and systems described herein. In some examples, article 60 may include a component of a gas turbine engine. For example, article 60 may include a part that forms a portion of a flow path structure, a seal segment, a blade track, an airfoil, a blade, a vane, a combustion chamber liner, or another portion of a gas turbine engine.

Article 60 may be similar to that of article 15 of FIG. 1. However, in article 60, EBC 14 includes optional bond coat 62 and EBC layer 64. Optional bond coat 62 of EBC 14 is on substrate 24. As shown in FIG. 5, bond coat 62 of EBC 14 may be directly on substrate 24. In other examples, one or more coatings or layers of EBC 14 may be between bond coat 62 and substrate 24.

Bond coat 62 may be between EBC layer 64 and substrate 24 and may increase the adhesion of EBC layer 64 to substrate 24. In some examples, bond coat 62 may include silicon and take the form of a silicon bond layer. In some examples, bond coat 62 may include silicon, a metal silicide, RE monosilicate, RE disilicate, hafnium silicate, mullite, SiC, a metal oxide or a mixture thereof. Bond coat 62 may be in direct contact with substrate 24 and EBC layer 64. In some examples, bond coat 62 has a thickness of approximately 25 microns to approximately 250 microns, although other thicknesses are contemplated.

In examples in which substrate 24 includes a ceramic or CMC, bond coat 62 may include a ceramic or another material that is compatible with the material from which substrate 24 is formed. For example, bond coat 62 may include mullite (aluminum silicate, Al₆Si₂O₁₃), silicon metal or alloy, silica, a silicide, or the like. Bond coat 62 may further include other elements, such as a rare earth silicate including a silicate of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), and/or scandium (Sc).

The composition of bond coat 62 may be selected based on the chemical composition and/or phase constitution of substrate 24 and the overlying layer (e.g., EBC layer 64). For example, if substrate 24 includes a ceramic or a CMC, bond coat 62 may include silicon metal or alloy or a ceramic, such as, for example, mullite.

In some cases, bond coat 62 may include multiple layers. For example, in some examples in which substrate 24 includes a CMC including silicon carbide, bond coat 62 may include a layer of silicon on substrate 24 and a layer of mullite, a rare earth silicate, or a mullite/rare earth silicate dual layer on the layer of silicon. In some examples, a bond coat 62 including multiple layers may provide multiple functions of bond coat 62, such as, for example, adhesion of substrate 24 to an overlying layer (e.g., EBC layer 64), chemical compatibility of bond coat 62 with each of substrate 24 and the overlying layer, a better coefficient of thermal expansion match of adjacent layers, or the like.

Bond coat 62 may be applied on substrate 24 using, for example, thermal spraying, e.g., air plasma spraying, high velocity oxy-fuel (HVOF) spraying, low vapor plasma spraying, suspension plasma spraying; physical vapor deposition (PVD), e.g., electron beam physical vapor deposition (EB-PVD), directed vapor deposition (DVD), cathodic arc deposition; chemical vapor deposition (CVD); slurry process deposition; sol-gel process deposition; electrophoretic deposition; or the like.

Coating 14 includes EBC layer 64, which may be configured to help protect substrate 24 against deleterious environmental species, such as CMAS and/or water vapor. EBC layer 64 may be a single layer or multiple layers, and may include at least one of a rare-earth oxide, a rare-earth silicate, an aluminosilicate, or an alkaline earth aluminosilicate. For example, EBC layer 64 may include mullite, barium strontium aluminosilicate (BSAS), barium aluminosilicate (BAS), or strontium aluminosilicate (SAS). In some examples, EBC layer 64 may include at least one rare-earth oxide, at least one rare-earth monosilicate (RE₂SiO₅, where RE is a rare-earth element), at least one rare-earth disilicate (RE₂Si₂O₇, where RE is a rare-earth element), or combinations thereof. The rare-earth element in the at least one rare-earth oxide, the at least one rare-earth monosilicate, or the at least one rare-earth disilicate may include at least one of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), praseodymium (Pr), cerium (Ce), lanthanum (La), yttrium (Y), or scandium (Sc).

FIG. 6 is a conceptual diagram illustrating another example article 70 including a substrate 24 and EBC 14. EBC 14 and substrate 24 may be the same or substantially similar to that of EBC 14 and substrate 24 of FIGS. 1 and 5 and are similarly numbered. However, unlike that of article 60 shown in FIG. 5, EBC 14 includes abradable layer 66 on EBC layer 64. In such a configuration, EBC 14 may be configured such that abradable layer 66 has a greater porosity than EBC layer 64, and the porosity of abradable layer 66 may be provided such that the outer surface of abradable layer 66 is abraded, e.g., when brought into contact with an opposing surface such as a blade tip. Abradable layer 66 may be on EBC layer 64, which may provide for better adhesion of abradable layer 66 to optional bond layer 62 or substrate 24. In some examples, abradable layer 66 may be about 0.005 inches (about 127 micrometers) to about 0.100 inches (about 2540 micrometers) thick. In other examples, layer 66 may have a different thickness. Although abradable layer 32 is shown as being formed on EBC layer 64, in other examples, EBC 14 of article 70 may not include EBC layer 64.

The composition of abradable layer 66 may be the same or substantially similar to that of the composition described above for EBC layer 64. In some examples, layer 64 or layer 66 may include a porosity of more than about 10 vol. %, such as more than about 20 vol. %, more than 30 vol. %, or more than about 40 vol. %, where porosity is measured as a percentage of pore volume divided by total volume of the respective layer. When configured as a non-abradable layer, EBC layer 64 may include a porosity of more than about 1 vol. %, such as more than about 2 vol. %, more than 3 vol. %, or about 5 vol. % to about 10 vol. %, where porosity is measured as a percentage of pore volume divided by total volume of EBC layer 64. When configured as an abradable layer, abradable layer 66 may include a porosity of more than about 15 vol. %, such as more than about 25 vol. %, more than 35 vol. %, or about 25 vol. % to about 45 vol. %, where porosity is measured as a percentage of pore volume divided by total volume of layer 66. In each case, the porosity of layers 64 and 66 may be measured using mercury porosimetry, optical microscopy or Archimedean method.

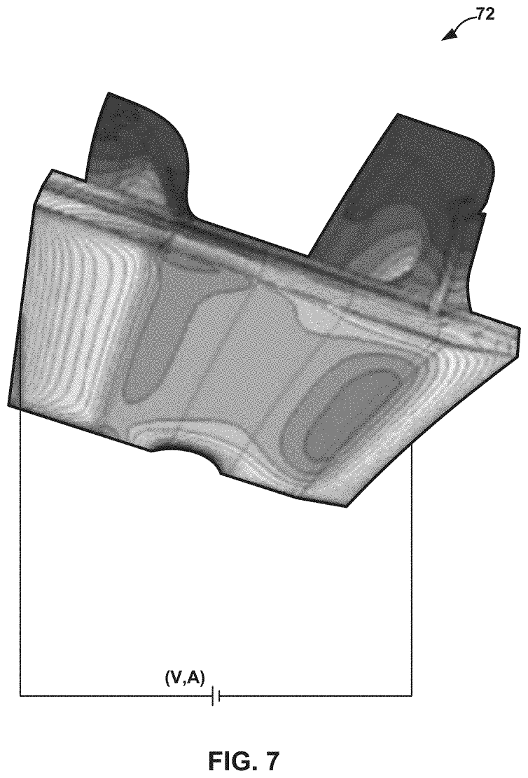

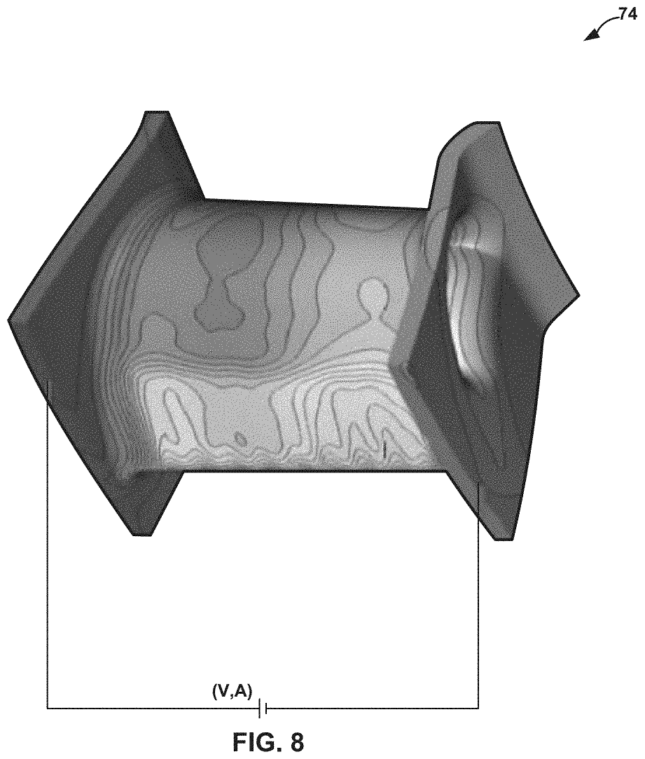

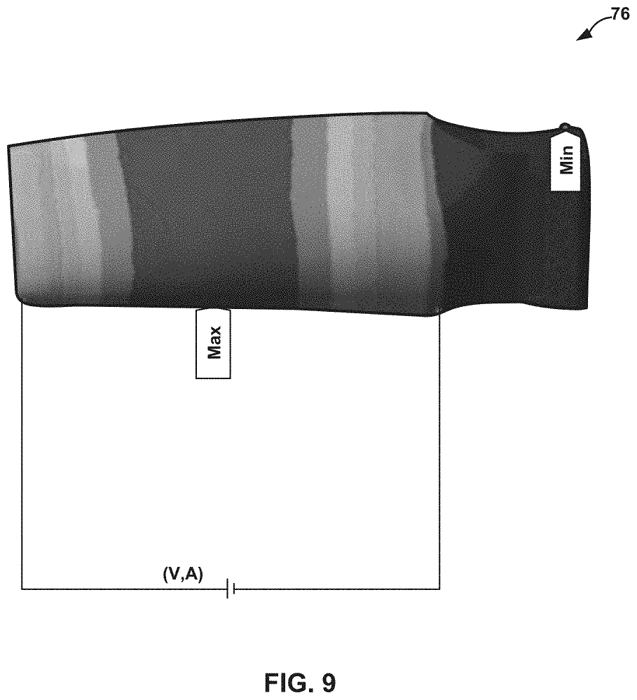

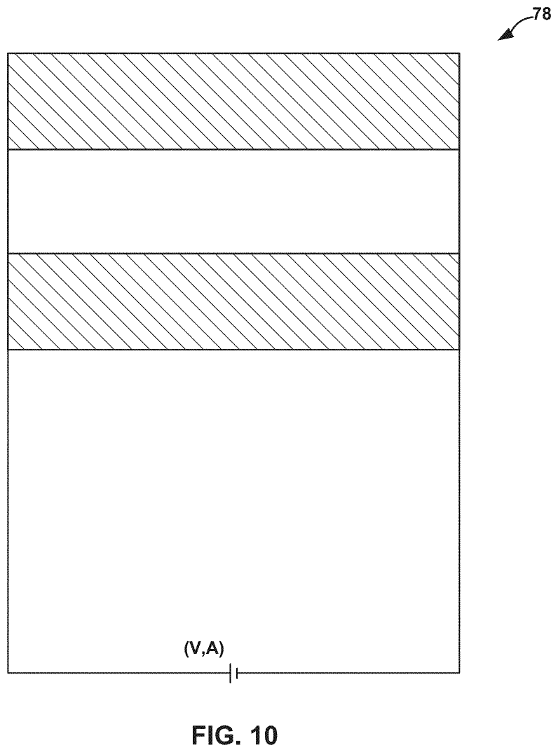

FIGS. 7-9 are conceptual diagrams illustrating resistive electrical heating of various example articles. The temperature gradient in each of FIGS. 7-9 are shown with the color blue representing a relatively low temperature and the colors red and green indicating a relatively high temperature. FIG. 7 illustrates an example electrical resistance heating flow path of a melt infiltrated SiC CMC seal segment 72. The blue portions reflect an area of relatively low temperature, e.g., as little or no current flows through those portions. FIG. 8 illustrates an example electrical resistance heating flow path of a melt infiltrated SiC CMC vane 74. FIG. 9 illustrates an example electrical resistance heating flow path of a melt infiltrated SiC CMC blade 76. FIG. 10 illustrates an example electrical resistance heating flow path (inner diameter or outer diameter) of a melt infiltrated SiC CMC combustor 78. As shown, no temperature gradient is present through the thickness/along the axial length.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

Various examples have been described. These and other examples are within the scope of the following claims and clauses.

Clause 1. A method comprising thermally spraying an environmental barrier coating (EBC) on a substrate to form an as-deposited EBC; and heat treating the as-deposited EBC following the deposition of the as-deposited EBC on the substrate, wherein heat treating the as-deposited EBC includes at least one of heating the substrate via resistive electrical heating to heat the as-deposited EBC or heating the as-deposited EBC via an external burner to form a heat-treated EBC, and wherein the heat treatment is configured to increase a weight percent of crystalline phase in the heat-treated EBC compared to the as-deposited EBC.

Clause 2. The method of clause 1, wherein heat treating the as-deposited EBC following the deposition of the as-deposited EBC on the substrate comprises: heating the substrate via the resistive electrical heating to heat the as-deposited EBC; and heating the as-deposited EBC via the external burner.

Clause 3. The method of clause 2, wherein heating the substrate via the resistive electrical heating to heat the as-deposited EBC, and heating the as-deposited EBC via the external burner comprises: heating the substrate via the resistive electrical heating to heat the as-deposited coating; and heating, substantially simultaneously with the resistive electrical heating, the as-deposited coating via the external burner.

Clause 4. The method of any one of clauses 1-3, wherein heat treating the as-deposited EBC following the deposition of the as-deposited EBC on the substrate comprises increasing a temperature of the as-deposited EBC to at least 900 degrees Celsius for a period of time.

Clause 5. The method of any one of clauses 1-4, wherein the period of time is at least one hour.

Clause 6. The method of any one of clauses 1-5, wherein the heat-treated EBC includes at least about 80 weight percent crystalline phase.

Clause 7. The method of any one of clauses 1-6, wherein the as-deposited EBC includes less than about 20 weight percent crystalline phase.

Clause 8. The method of any one of clauses 1-7, wherein the heat-treated EBC defines a crystalline phase gradient through a thickness of the heat-treated EBC.

Clause 9. The method of any one of clauses 1-8, further comprising heating the substrate at least one of before or during a deposition of the EBC via thermal spraying, wherein the substrate is heated via at least one of resistive electrical heating or an external burner.

Clause 10. The method of any one of clauses 1-9, wherein the EBC comprises a bond layer and an EBC layer.

Clause The method of clause 10, wherein the bond layer comprises at least one of a silicon bond layer or a mullite layer.

Clause 12. The method of clause 10, wherein the EBC layer comprises a rare earth silicate.

Clause The method of any one of clauses 1-12, wherein the substrate comprises a ceramic or ceramic matrix composite substrate.

Clause 14. The method of clause 13, wherein the substrate comprises the CMC substrate, the CMC substrate comprising SiC including free silicon.

Clause 15. The method of any one of clauses 1-14, wherein heating the substrate via resistive electrical heating includes conducting a current through the substrate, wherein resistance of the substrate heats the substrate, and wherein heat from the heated substrate is conducted into the as-deposited EBC to heat the as-deposited EBC.

Clause 16. The method of any one of clauses 1-15, further comprising heating treating the as-deposited EBC during the deposition of the as-deposited EBC on the substrate, wherein heat treating the as-deposited EBC during the deposition includes at least one of heating the substrate via resistive electrical heating to heat the as-deposited EBC or heating the as-deposited EBC via an external burner to form a heat-treated EBC.

Clause 17. A method comprising thermally spraying an environmental barrier coating (EBC) on a substrate to form an as-deposited EBC; and heating the substrate to an elevated temperature at least one of before or during the deposition on the EBC on the substrate, wherein heating the substrate comprises at least one of heating the substrate via resistive electrical heating or heating a deposition surface of the substrate via an external burner.

Clause 18. The method of clause 17, wherein heat treating the substrate comprises heating the substrate via the resistive electrical heating; and heating the deposition surface of the substrate via the external burner.

Clause 19. The method of clause 18, wherein heating the substrate via the resistive electrical heating, and heating the deposition surface of the substrate via the external burner comprises heating the substrate via the resistive electrical heating; and heating, substantially simultaneously with the resistive electrical heating, the deposition surface of the substrate via the external burner.

Clause 20. The method of any one of clauses 17-19, wherein the elevated temperature is at least about 900 degrees Celsius.

Clause 21. The method of any one of clauses 17-20, wherein a deposition surface of the substrate is at least about 900 degrees Celsius while the EBC is deposited on the substrate.

Clause 22. The method of any one of clauses 17-21, wherein a temperature of a deposition surface of the substrate is at or above a crystalline transition temperature of the EBC when the EBC is deposited on the substrate.

Clause 23. The method of any one of clauses 17-22, wherein the substrate is not heated by a heating source other than the resistive electrical heating or external burner during the deposition of the EBC on the substrate.

Clause 24. The method of any one of clauses 17-23, wherein the deposited EBC includes at least about 20 weight percent crystalline phase.

Clause 25. The method of any one of clauses 17-24, further comprising heat treating the as-deposited EBC following the deposition of the as-deposited EBC on the substrate, wherein heat treating the as-deposited EBC includes at least one of heating the substrate via the resistive electrical heating to heat the as-deposited EBC or heating the as-deposited EBC via the external burner.

Clause 26. The method of clause 25, wherein the heat-treated EBC includes at least about 80 weight percent crystalline phase.

Clause 27. The method of any one of clauses 17-26, wherein heating the substrate via resistive electrical heating includes conducting a current through the substrate, wherein resistance of the substrate heats the substrate, and wherein heat from the heated substrate is conducted into the as-deposited EBC to heat the as-deposited EBC.

Clause 28. A method comprising thermally spraying an environmental barrier coating (EBC) on a substrate to form an as-deposited EBC; and heat treating the as-deposited EBC during and following the deposition of the as-deposited EBC on the substrate, wherein heat treating the as-deposited EBC includes at least one of heating the substrate via resistive electrical heating to heat the as-deposited EBC or heating the as-deposited EBC via an external burner to form a heat-treated EBC, and wherein the heat treatment is configured to increase a weight percent of crystalline phase in the heat-treated EBC compared to the as-deposited EBC.

Clause 29. A system comprising means for performing a method according to any one of clauses 1-28.

1. A method comprising:
thermally spraying an environmental barrier coating (EBC) on a substrate to form an as-deposited EBC; and
heat treating the as-deposited EBC following the deposition of the as-deposited EBC on the substrate, wherein heat treating the as-deposited EBC includes at least one of heating the substrate via resistive electrical heating to heat the as-deposited EBC or heating the as-deposited EBC via an external burner to form a heat-treated EBC, and
wherein the heat treatment is configured to increase a weight percent of crystalline phase in the heat-treated EBC compared to the as-deposited EBC.

2. The method of claim 1, wherein heat treating the as-deposited EBC following the deposition of the as-deposited EBC on the substrate comprises:
heating the substrate via the resistive electrical heating to heat the as-deposited EBC; and
heating the as-deposited EBC via the external burner.

3. The method of claim 2, wherein heating the substrate via the resistive electrical heating to heat the as-deposited EBC, and heating the as-deposited EBC via the external burner comprises:
heating the substrate via the resistive electrical heating to heat the as-deposited coating; and
heating, substantially simultaneously with the resistive electrical heating, the as-deposited coating via the external burner.

4. The method of claim 1, wherein heat treating the as-deposited EBC following the deposition of the as-deposited EBC on the substrate comprises increasing a temperature of the as-deposited EBC to at least 900 degrees Celsius for a period of time.

5. The method of claim 1, wherein the period of time is at least one hour.

6. The method of claim 1, wherein the heat-treated EBC includes at least about 80 weight percent crystalline phase.

7. The method of any one of claim 1, wherein the as-deposited EBC includes less than about 20 weight percent crystalline phase.

8. The method of claim 1, wherein the heat-treated EBC defines a crystalline phase gradient through a thickness of the heat-treated EBC.

9. The method of claim 1, further comprising heating the substrate at least one of before or during a deposition of the EBC via thermal spraying, wherein the substrate is heated via at least one of resistive electrical heating or an external burner.

10. The method of claim 1, wherein the EBC comprises a bond layer and an EBC layer.

11. The method of claim 10, wherein the bond layer comprises at least one of a silicon bond layer or a mullite layer.

12. The method of claim 10, wherein the EBC layer comprises a rare earth silicate.

13. The method of claim 1, wherein the substrate comprises a ceramic or ceramic matrix composite substrate.

14. The method of claim 13, wherein the substrate comprises the CMC substrate, the CMC substrate comprising SiC including free silicon.

15. The method of claim 1, wherein heating the substrate via resistive electrical heating includes conducting a current through the substrate, wherein resistance of the substrate heats the substrate, and wherein heat from the heated substrate is conducted into the as-deposited EBC to heat the as-deposited EBC.

16. The method of claim 1, further comprising heating treating the as-deposited EBC during the deposition of the as-deposited EBC on the substrate, wherein heat treating the as-deposited EBC during the deposition includes at least one of heating the substrate via resistive electrical heating to heat the as-deposited EBC or heating the as-deposited EBC via an external burner to form a heat-treated EBC.

17. A method comprising:
thermally spraying an environmental barrier coating (EBC) on a substrate to form an as-deposited EBC; and
heating the substrate to an elevated temperature at least one of before or during the deposition on the EBC on the substrate, wherein heating the substrate comprises at least one of heating the substrate via resistive electrical heating or heating a deposition surface of the substrate via an external burner.

18. The method of claim 17, wherein heat treating the substrate comprises:
heating the substrate via the resistive electrical heating; and
heating the deposition surface of the substrate via the external burner.

19. The method of claim 18, wherein heating the substrate via the resistive electrical heating, and heating the deposition surface of the substrate via the external burner comprises:
heating the substrate via the resistive electrical heating; and
heating, substantially simultaneously with the resistive electrical heating, the deposition surface of the substrate via the external burner.

20. A method comprising:
thermally spraying an environmental barrier coating (EBC) on a substrate to form an as-deposited EBC; and
heat treating the as-deposited EBC during and following the deposition of the as-deposited EBC on the substrate, wherein heat treating the as-deposited EBC includes at least one of heating the substrate via resistive electrical heating to heat the as-deposited EBC or heating the as-deposited EBC via an external burner to form a heat-treated EBC, and
wherein the heat treatment is configured to increase a weight percent of crystalline phase in the heat-treated EBC compared to the as-deposited EBC.
